(19) United States
(12) Patent Application Publication
(10) Pub. No.: US 2017/0225434 A1
(43) Pub. Date: Aug. 10, 2017

(54) ALUMINIUM OXIDE COMPOSITION, SUBSTRATE COMPRISING SAME, AND MANUFACTURING METHOD THEREOF

(71) Applicant: LG CHEM, LTD., Seoul (KR)

(72) Inventors: Donghyun LEE, Daejeon (KR); Seung Heon LEE, Daejeon (KR); Jiehyun SEONG, Daejeon (KR); Joo Yeon KIM, Daejeon (KR); Sarah KIM, Daejeon (KR); Jung Yeon LEE, Daejeon (KR); Nam Seok BAE, Daejeon (KR)

(73) Assignee: LG CHEM, LTD., Seoul (KR)

(21) Appl. No.: 15/502,933

(22) PCT Filed: Aug. 11, 2015
(86) PCT No.: PCT/KR2015/008414

§ 371 Date: Feb. 9, 2017

(30) Foreign Application Priority Data
Aug. 11, 2014 (KR) 10-2014-0103911
Mar. 16, 2015 (KR) 10-2015-0036093
Jun. 22, 2015 (KR) 10-2015-0088650

(51) Int. Cl. B32B 15/20; B32B 15/02

(52) U.S. Cl. CPC B32B 15/20; B32B 15/02

(57) ABSTRACT

The present specification relates to an aluminum oxide composition, a substrate including the same, and a method for manufacturing the same.

### TECHNICAL FIELD

The present specification claims priority to and the benefit of Korean Patent Application No. 10-2014-0103911 filed in the Korean Intellectual Property Office on Aug. 11, 2014, Korean Patent Application No. 10-2015-0036093 filed in the Korean Intellectual Property Office on Mar. 16, 2015, and Korean Patent Application No. 10-2015-0088650 filed in the Korean Intellectual Property Office on Jun. 22, 2015, the contents of which are incorporated herein by reference in their entireties.

The present specification relates to an aluminum oxide composition, a substrate including the same, and a method for manufacturing the same

### BACKGROUND ART

Aluminum is a light-weight metal diversely used in various fields, and various separate coating agents have been used or chemical solutions have been used in order to change the characteristics of aluminum.

However, generally, aluminum have problems in that production costs may be increased and environmental contaminants may be generated, and accordingly, studies have been conducted in order to alleviate the problem.

### CITATION LIST

### Patent Document

Official Gazette of International Publication No. 2007-064003

### DETAILED DESCRIPTION OF THE INVENTION

### Technical Problem

An object of the present specification is to provide an aluminum oxide composition which is chemically stable and economically efficient in terms of costs, and to which characteristics is imparted by an eco-friendly method.

### Technical Solution

An exemplary embodiment of the present specification provides an aluminum oxide composition including oxygen and aluminum, in which based on the total atoms of the total aluminum oxide composition, the content of oxygen is 40 atomic ratios to 70 atomic ratios and the content of aluminum is 30 atomic ratios to 60 atomic ratios.

An exemplary embodiment of the present specification provides a substrate including: a substrate; an aluminum layer provided on at least one surface on the substrate and including one or more of aluminum, aluminum nitride, and aluminum oxynitride; and the above-described aluminum oxide composition provided on at least a portion of an upper surface and side surfaces of the aluminum layer.

Further, an exemplary embodiment of the present specification provides a substrate including: a substrate; and the above-described aluminum oxide composition provided on at least one surface on the substrate.

An exemplary embodiment of the present specification provides a method for preparing an aluminum oxide composition, the method including: immersing an aluminum layer including one or more of aluminum, aluminum nitride, and aluminum oxynitride in water.

Finally, an exemplary embodiment of the present specification provides a method for manufacturing a substrate, the method including: preparing a substrate; forming an aluminum layer including one or more of aluminum, aluminum nitride, and aluminum oxynitride on at least one surface on the substrate; and forming an aluminum oxide composition on at least a portion of an upper surface and side surfaces of the aluminum layer by the above-described method for preparing an aluminum oxide composition.

### Advantageous Effects

A substrate according to an exemplary embodiment of the present specification includes a transparent aluminum oxide composition to impart hydrophilic characteristics to the surface thereof.

In the present specification, a transparent aluminum oxide composition may be included to form a transparent substrate. Further, the aluminum oxide composition uses oxides, and thus is stable from the external environments.

In addition, since a coating with a surface modifying material or a surface treatment of plasma need not be separately performed through a relatively simple surface modification, there is economic efficiency in terms of process time and/or costs.

A substrate according to another exemplary embodiment has an effect of improving adhesion according to the degree of oxidation process, and may adjust a sheet resistance by adjusting the process time.

Additionally, a substrate according to still another exemplary embodiment has excellent transparency and a low haze value.

### BRIEF DESCRIPTION OF DRAWINGS

FIG. 1 is a view illustrating the X-ray diffraction (XRD) of an aluminum oxide composition according to an exemplary embodiment of the present specification.

FIGS. 2 to 4 are views illustrating the results of a change in content of the aluminum oxide composition according to an exemplary embodiment of the present specification in a depth direction, which are analyzed by X-ray photoelectron spectrometer.

FIG. 5 is a view illustrating a cross-section of a substrate according to an exemplary embodiment of the present specification, which is measured by HR-TEM.

FIG. 6 is a view illustrating an analyzed result of the diffraction pattern of an aluminum layer according to an exemplary embodiment of the present specification.

FIG. 7 is a view illustrating an analyzed result of the diffraction pattern of an aluminum oxide composition according to an exemplary embodiment of the present specification.

FIG. 8 is a view illustrating an analyzed result of a selected area diffraction pattern (SADP) of a substrate according to an exemplary embodiment of the present specification.

FIGS. 9 to 13 are views exemplifying the side surface structure of a substrate according to an exemplary embodiment of the present specification.

FIG. 14 is a view illustrating the contact angle of a substrate with respect to water before and after immersing the substrate in water.

FIG. 15 is a view illustrating a surface of an aluminum oxide composition layer observed by a scanning electron microscope (SEM) over the time when the aluminum oxide composition layer is immersed in water.

FIG. 16 is a graph showing the adhesion and sheet resistance value over the time when the aluminum oxide composition layer is immersed in water.

FIG. 17 is a view illustrating the thickness of an aluminum layer observed by a scanning electron microscope (SEM) before and after the aluminum layer is immersed in water.

FIG. 18 is a view illustrating an observation of the transmittance over the time when an aluminum layer is immersed in water.

FIG. 19 is a graph showing the transmittance over the time when an aluminum layer is immersed in water.

FIG. 20 is a graph showing the transmittance over the time when an aluminum layer is immersed in water.

FIG. 21 is a graph showing the haze value over the time when an aluminum layer is immersed in water.

FIG. 22 is a graph showing the transmittances of the substrates manufactured in Comparative Example 2 and Example 7 in a region from 300 nm to 2,300 nm.

FIG. 23 is a graph showing the reflectances of the substrates manufactured in Comparative Example 2 and Example 7 in a region from 300 nm to 2,300 nm.

FIG. 24 is a view illustrating the production rate of an aluminum oxide composition over the pH range of water.

### EXPLANATION OF REFERENCE NUMERALS AND SYMBOLS

101: Substrate
102: Aluminum layer
103: Aluminum oxide composition
a: Line width of aluminum layer
b: Thickness of aluminum layer

### BEST MODE

When one member is disposed “on” another member in the present specification, this includes not only a case where the one member is brought into contact with another member, but also a case where still another member is present between the two members.

When one part “includes” one constituent element in the present specification, unless otherwise specifically described, this does not mean that another constituent element is excluded, but means that another constituent element may be further included.

Hereinafter, the present specification will be described in more detail.

Aluminum Oxide Composition and Method for Preparing the Same

An exemplary embodiment of the present specification provides an aluminum oxide composition including oxygen and aluminum, in which based on the total atoms of the total aluminum oxide composition, the content of oxygen is 40 atomic ratios to 70 atomic ratios and the content of aluminum is 30 atomic ratios to 60 atomic ratios.

In an exemplary embodiment of the present specification, the aluminum oxide composition is prepared by including immersing an aluminum layer including one or more of aluminum, aluminum nitride, and aluminum oxynitride in water.

In general, the reaction in the oxidation form of aluminum may be carried out as described below, and the aluminum oxide composition according to an exemplary embodiment of the present specification is composed of boehmite (AlO(OH)), bayerite (Al(OH)₃), Al₂O₃, and aluminum.

2Al+6H₂O [symbol] 2Al(OH)₃+3H₂

2Al+4H₂O [symbol] 2AlO(OH)+3H₂

2Al+3H₂O [symbol] Al₂O₃+3H₂

The aluminum oxide composition according to an exemplary embodiment of the present specification includes oxygen in a content of 40 atomic ratios to 70 atomic ratios and aluminum in a content of 30 atomic ratios to 60 atomic ratios, based on the total atoms of the total aluminum oxide composition. More specifically, the content of oxygen is 55 atomic ratios to 60 atomic ratios, and the content of aluminum is 40 atomic ratios to 45 atomic ratios.

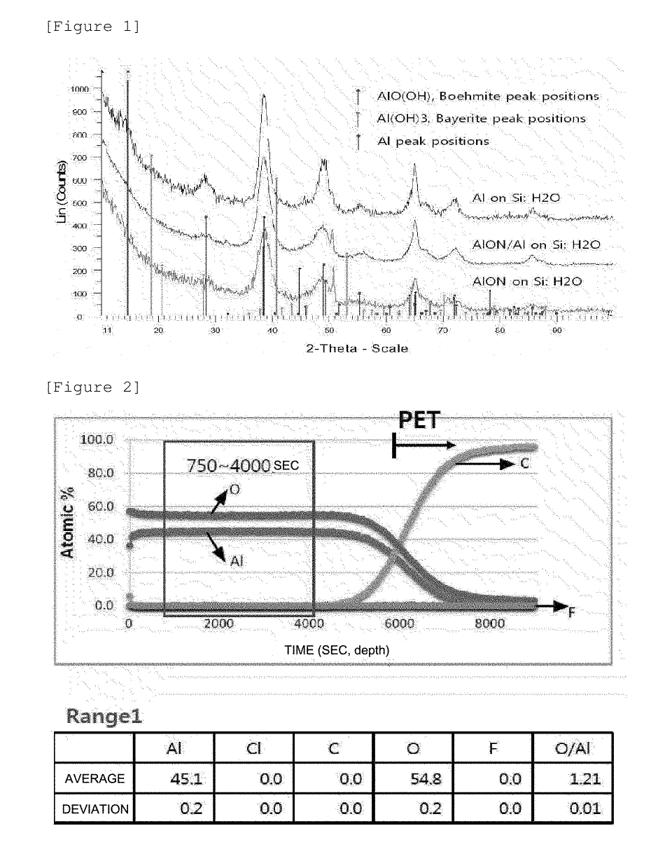

FIG. 1 is a view illustrating the X-ray diffraction (XRD) of an aluminum oxide composition according to an exemplary embodiment of the present specification.

In FIG. 1, each aluminum layer of aluminum, a laminate of aluminum oxynitride and aluminum, and aluminum oxynitride is immersed in deionized water (DI water) at 100° C. for 3 minutes to 5 minutes to form an aluminum oxide composition, and the measurement was made by using a photoelectron spectrometer (XPS or ESCA)—model name: K-Alpha (Thermo Fisher Scientific).
Analysis conditions: PANalytical Expert Pro MRD XRD, Voltage: 45 kV, Current: 40 am, Cu K-α radiation (Wavelength: 1.5418 ÅA)

From the results of FIG. 1, the composition of the aluminum oxide composition to which characteristics are imparted may be confirmed.

Further, FIGS. 2 to 4 are views illustrating the results of a change in content of the aluminum oxide composition according to an exemplary embodiment of the present specification in a depth direction, which are analyzed by X-ray photoelectron spectrometer.

FIG. 2 is a view in which aluminum is laminated to have a thickness of 100 nm on a PET substrate, and then the PET substrate is immersed in deionized water (DI water) to form an aluminum oxide composition, and the ratios of elements are measured according to the depth direction.

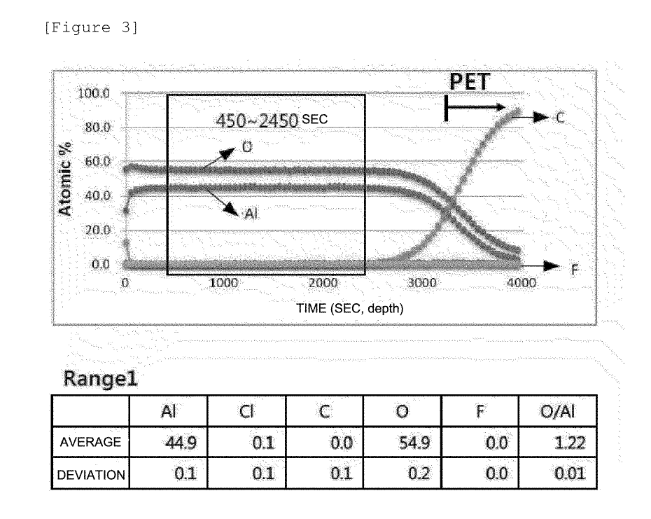

FIG. 3 is a view in which aluminum is laminated to have a thickness of 50 nm and aluminum oxynitride is laminated to have a thickness of 50 nm on a PET substrate, and then the PET substrate is immersed in deionized water (DI water) to form an aluminum oxide composition, and the ratios of elements are measured according to the depth direction.

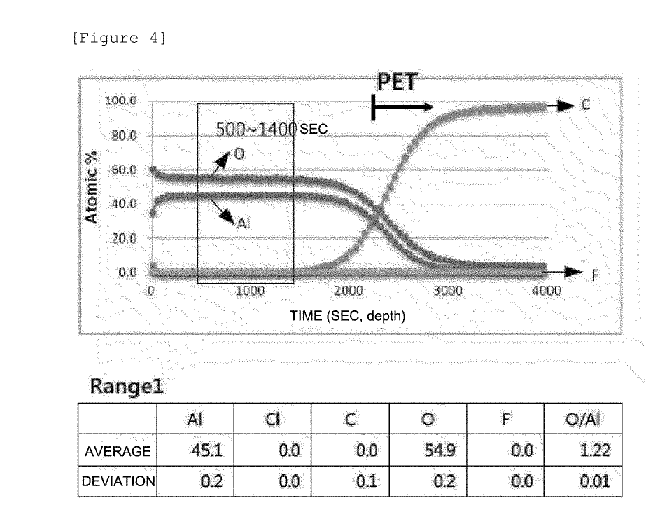

FIG. 4 is a view in which aluminum oxynitride is laminated to have a thickness of 100 nm on a PET substrate, and then the PET substrate is immersed in deionized water (DI water) to form an aluminum oxide composition, and the ratios of elements are measured according to the depth direction.

In FIGS. 2 to 4, a photoelectron spectrometer (XPS or ESCA)—model name: K-Alpha (Thermo Fisher Scientific) was used, and the etching conditions of argon (Ar) ion were 3,000 eV, high, and 1.5 mm.

The aluminum oxide composition according to an exemplary embodiment of the present specification may be represented by Al₂O₃₋ₓ, and the range of x is an integer of more than 0.4 and less than 1.0.

In an exemplary embodiment of the present specification, the aluminum oxide composition is prepared by including immersing an aluminum layer including one or more of aluminum, aluminum nitride, and aluminum oxynitride in water.

In one exemplary embodiment, the temperature of the water is 40° C. to 100° C. Within the temperature range, the aluminum oxide composition is economically efficient in terms of time and/or costs. Specifically, when the aluminum layer is immersed in water at less than 40° C., the aluminum oxide composition is slowly produced, so that the treatment time may be increased.

In an exemplary embodiment of the present specification, the formed aluminum layer is immersed in water for 30 minutes or less. In an exemplary embodiment of the present specification, the formed aluminum layer is immersed in water for 10 minutes to 30 minutes. The time for immersing the aluminum layer in water may be adjusted according to the water temperature and/or the degree of a required surface modification.

In an exemplary embodiment of the present specification, the water in which the aluminum layer is immersed further includes a base. Specifically, in an exemplary embodiment of the present specification, examples of the base include KOH, and the like, but the base is not limited as long as the base may impart basicity to water.

In an exemplary embodiment of the present specification, the pH range of the water is pH 7 to pH 13. More specifically, in an exemplary embodiment of the present specification, the pH range of the water is pH 8 to pH 13. In another exemplary embodiment, the pH range of the water is pH 9 to pH 12.

As in an exemplary embodiment of the present specification, when the water further includes a base, the reaction rate of production of the aluminum oxide composition may be increased.

FIG. 24 is a view illustrating the production rate of an aluminum oxide composition over the pH range of water. From the results of FIG. 24, it can be confirmed that as the basicity of water is increased, the production rate of the aluminum oxide composition is significantly increased.

Accordingly, the basicity of water may be adjusted according to the degree of a required surface modification of the aluminum oxide layer.

A method for manufacturing a substrate according to an exemplary embodiment of the present specification includes immersing the aluminum oxide layer in water to oxidize the aluminum oxide layer, and thus may easily perform the surface modification of a substrate composed by a simple process without using a separate coating agent or using a chemical solution, and may adjust imparting required physical properties, if necessary, by adjusting the time for immersing the substrate in water and the water temperature, and accordingly, the method is effective in terms of costs and time.

Further, since a separate coating agent or a chemical solution is not used, the method is less toxic to the human body and is eco-friendly.

The method for manufacturing a substrate according to an exemplary embodiment of the present specification may manufacture a substrate through a relatively simple process of immersing the aluminum layer in water to oxidize the aluminum layer without a separate surface modification procedure, and thus is economically efficient in terms of process time and/or costs.

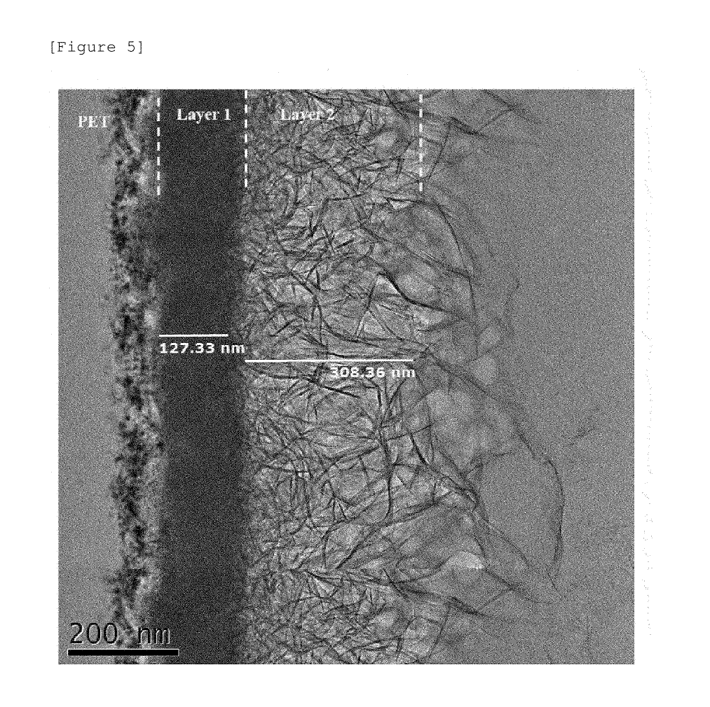

FIG. 5 is a view illustrating a cross-section of a substrate according to an exemplary embodiment of the present specification, which is measured by HR-TEM.

In FIG. 5, the measurement was made by using Titan G2 80-200 field emission transmission electron microscope specification.

FIG. 6 is a view illustrating an analyzed result of the diffraction pattern of an aluminum layer according to an exemplary embodiment of the present specification.

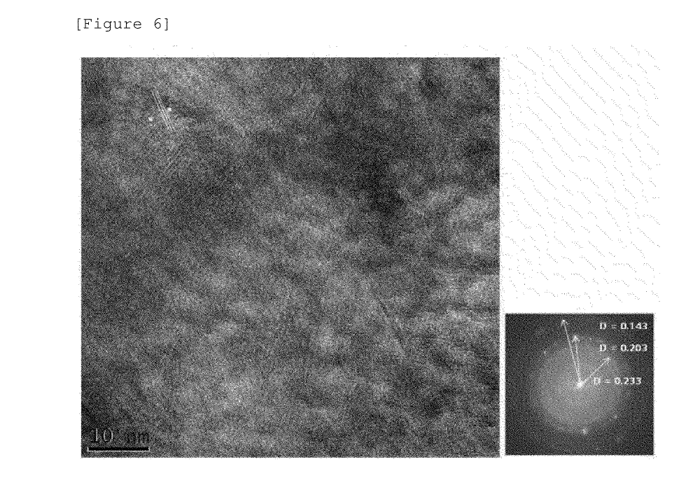

FIG. 7 is a view illustrating an analyzed result of the diffraction pattern of an aluminum oxide composition according to an exemplary embodiment of the present specification.

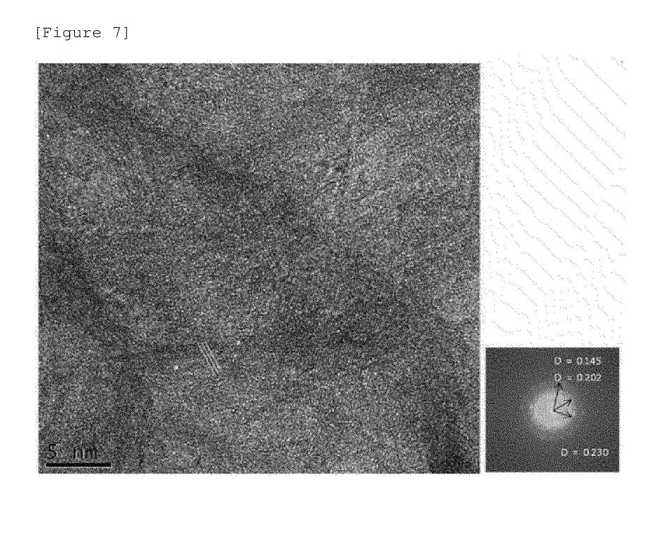

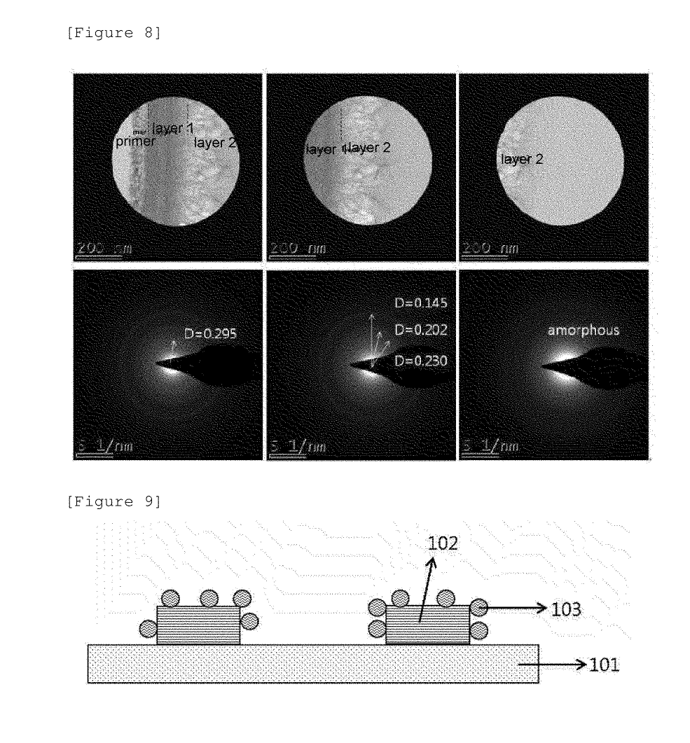

FIG. 8 is a view illustrating an analyzed result of a selected area diffraction pattern (SADP) of a substrate according to an exemplary embodiment of the present specification.

From the results of FIGS. 5 to 8, the above-described aluminum oxide composition is formed through the immersing of the aluminum layer in water to form an aluminum oxide composition. Specifically, D=0.295 of FIG. 8 is a zirconium oxide diffraction pattern of a substrate, and it can be confirmed that as the pattern becomes closer to a direction of immersing the aluminum layer in water, the ratio of the aluminum oxide composition of the amorphous pattern is increased.

As a result, it can be confirmed that an aluminum oxide composition having characteristics of a large deviation in thickness and a decrease in film density is formed. This is because the volume is expanded during the oxidation procedure, or hydrogen gas is generated, and as a result, the aluminum oxide composition is irregularly formed.

Therefore, according to an exemplary embodiment of the present specification, when an aluminum layer is immersed in water, the aluminum layer is oxidized from the immersed direction to the depth direction, and as a result, it can be confirmed that an aluminum oxide composition having an amorphous structure is formed while the thickness of a relatively dense aluminum layer is decreased.

Substrate Including Aluminum Oxide Composition and Method for Manufacturing the Same

An exemplary embodiment of the present specification provides a substrate including: a substrate; an aluminum layer provided on at least one surface of the substrate and including one or more of aluminum, aluminum nitride, and aluminum oxynitride; and the above-described aluminum oxide composition provided on at least a portion of an upper surface and side surfaces of the aluminum layer.

Further, an exemplary embodiment of the present specification provides a substrate including: a substrate; and the above-described aluminum oxide composition provided on at least one surface on the substrate.

An exemplary embodiment of the present specification provides a method for manufacturing a substrate, the method including: preparing a substrate; forming an aluminum layer including one or more of aluminum, aluminum nitride, and aluminum oxynitride on at least one surface on the substrate; and forming an aluminum oxide composition on at least a portion of an upper surface and side surfaces of the aluminum layer by the above-described method for preparing an aluminum oxide composition.

In the present specification, the aluminum oxide composition and the method for preparing the same are the same as those described above.

In an exemplary embodiment of the present specification, the aluminum layer is in the form of a film or a pattern.

In an exemplary embodiment of the present specification, the aluminum pattern may be a mesh pattern. The mesh pattern may include a regular polygonal pattern including one or more forms of a triangle, a quadrilateral, a pentagon, a hexagon, and an octagon, and the shape, pattern, line width, and the like of the aluminum pattern are not limited.

In an exemplary embodiment of the present specification, the forming of the aluminum layer may use a method generally used in forming a metal layer. The layer may be formed by using a printing method, a photolithography method, a photography method, a method using a mask, or laser transfer, and the like, and the method is not limited thereto.

According to an exemplary embodiment of the present specification, the aluminum layer has a thickness of more than 0 μm and 10 μm or less. Specifically, the aluminum layer has a thickness of 150 nm to 200 nm. The thickness of the aluminum layer may be adjusted by a person skilled in the art, if necessary.

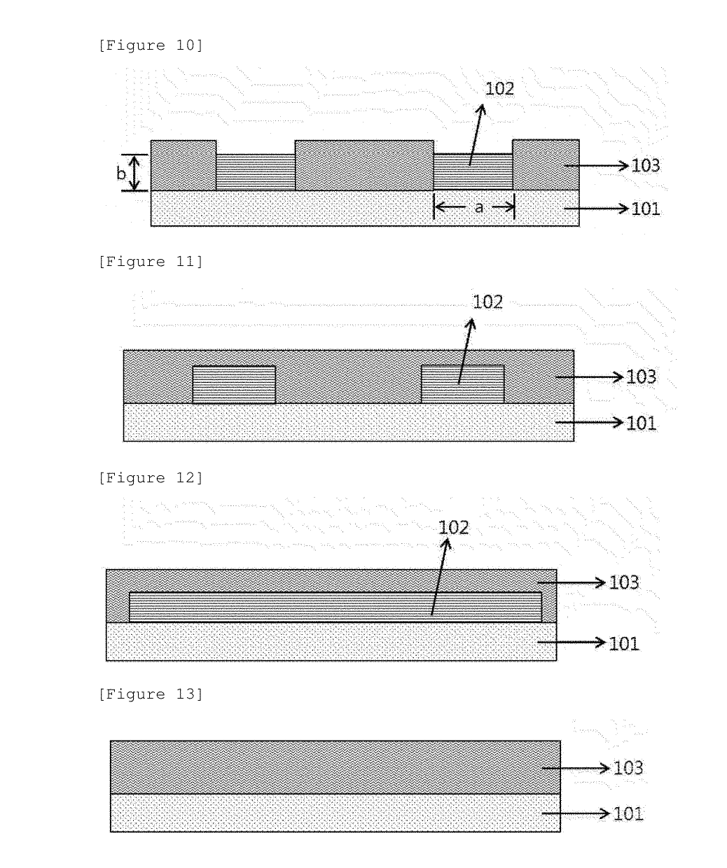

In the present specification, the thickness of the aluminum layer means a width between one surface on which an aluminum oxide composition is not formed and one surface to facing the surface. In FIG. 10, the width at the b portion corresponds to the thickness of the aluminum layer.

Further, in an exemplary embodiment of the present specification, the specific surface area is increased by 5 times to 10 times or more after the immersing of the aluminum layer in water to form an aluminum oxide composition.

The specific surface area may be quantified through the Brunauer-Emmett-Teller (BET) measurement, but the quantification method is not limited thereto.

In the present specification, the specific surface area means a surface area per unit volume. After the forming of the aluminum oxide composition as described above, an increase in specific surface area is because the volume is expanded or hydrogen gas is generated while the aluminum oxide composition is formed, and as a result, the form of the thin film is changed.

Therefore, it can be confirmed that the aluminum oxide composition is formed due to the change in specific surface area.

A substrate including the aluminum oxide composition according to an exemplary embodiment of the present specification and a substrate manufactured by the above-described method may have characteristics as described below.

Hereinafter, the characteristics will be described in detail.

Hydrophilic Surface Modification

A substrate including the aluminum oxide composition according to an exemplary embodiment of the present specification has hydrophilic characteristics.

An exemplary embodiment of the present specification provides a substrate including: a substrate; an aluminum layer provided on at least one surface of the substrate and including one or more of aluminum, aluminum nitride, and aluminum oxynitride; and the above-described aluminum oxide composition provided on at least a portion of an upper surface and side surfaces of the aluminum layer.

In an exemplary embodiment of the present specification, an aluminum oxide composition is irregularly provided on at least a portion of an upper surface and side surfaces of the aluminum layer.

In the present specification, the upper surface means a surface facing a surface adjacent to a substrate.

Being irregularly provided may mean being provided at an irregular position on an aluminum layer, and may also mean that the form of the aluminum oxide composition is provided in an irregular form.

In an exemplary embodiment of the present specification, the aluminum oxide composition may be provided in a form of an island, and has an irregular form.

For example, the substrate according to an exemplary embodiment of the present specification may be the same as that in FIG. 9.

In an exemplary embodiment of the present specification, the contact angle of a substrate including an aluminum layer, on which the aluminum oxide composition is provided, with respect to water is 10 degrees or less. In another exemplary embodiment, the contact angle of a substrate including an aluminum layer, on which the aluminum oxide composition is provided, with respect to water is 3.5 degrees or less.

In the present specification, the contact angle of a substrate with respect to water means an angle between surfaces on a substrate in which water and the substrate are brought into contact with each other. A small contact angle has a high-level wettability of a surface, that is, high hydrophilicity.

Therefore, a substrate having the contact angle as described above has surface characteristics of a hydrophilic substrate having high wettability.

In an exemplary embodiment of the present specification, the aluminum oxide composition is provided at 90% or more of an area of one surface of the aluminum layer facing the substrate. The volume is expanded in the procedure of forming an aluminum oxide composition by immersing an aluminum layer in water at a predetermined temperature, and accordingly, the form of the aluminum thin film is changed.

Since the aluminum oxide composition may act as a structure which imparts hydrophilic characteristics to a substrate, and is present in a transparent form, the structure is invisible when the composition is applied to a device, and the composition is provided in an oxide form, and thus has excellent stability for the external environments.

Further, the aluminum oxide composition has high transmittance, and thus may make an opaque aluminum layer transparent. In addition, the range in which the aluminum oxide composition is produced may be adjusted according to the reaction time and the water temperature.

An exemplary embodiment of the present specification provides a method for manufacturing a substrate, the method including: preparing a substrate; forming an aluminum layer including one or more of aluminum, aluminum nitride, and aluminum oxynitride on at least one surface on the substrate; and forming an aluminum oxide composition on at least a portion of an upper surface and side surfaces of the aluminum layer by the above-described method for preparing an aluminum oxide composition.

The forming of the aluminum oxide composition is the same as that described above.

In an exemplary embodiment of the present specification, after the immersing of the aluminum layer to oxidize the aluminum layer, the contact angle of the substrate with respect to water is decreased to 10 degrees or less within 1 minute.

FIG. 14 is a view illustrating the contact angle of a substrate with respect to water before and after immersing the substrate in water. In FIG. 14, it can be seen that after the substrate is immersed in water, the contact angle of the substrate with respect to water is changed from 92.2 degrees to 3.5 degrees or less.

Therefore, in the case of the substrate according to an exemplary embodiment of the present specification, it can be confirmed that the aluminum oxide composition decreases the contact angle of the substrate with respect to water, that is, imparts a hydrophilic surface modification effect to a substrate.

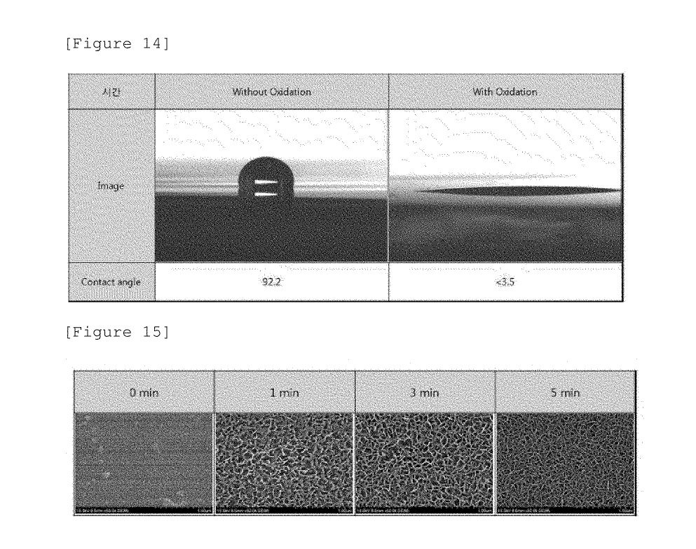

FIG. 15 is a view illustrating a substrate of an aluminum oxide composition layer observed by a scanning electron microscope (SEM) over the time when the aluminum oxide composition layer is immersed in water.

Through FIGS. 14 and 15, it can be seen that the formed aluminum oxide composition decreases the contact angle of the substrate with respect to water, that is, imparts a hydrophilic surface modification effect to a substrate.

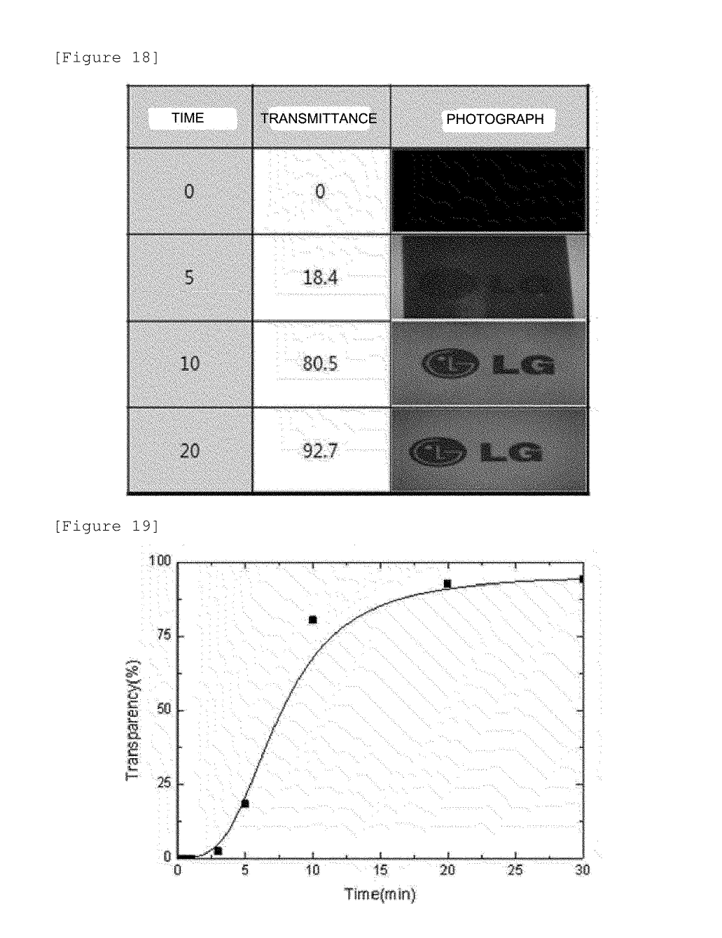

FIG. 18 is a view illustrating an observation of the transmittance over the time when an aluminum layer is immersed in water.

FIG. 19 is a graph showing the transmittance over the time when an aluminum layer is immersed in water.

As a result of observing the transparency in FIGS. 18 and 19, it can be confirmed that the transmittance is improved by 18.4% within 5 minutes, and from 5 minutes later, letters are visible due to high transparency.

Therefore, through FIGS. 18 and 19, it can be confirmed that when an aluminum layer is provided on a substrate and an aluminum oxide composition is provided on at least a portion of the aluminum layer, a transparent substrate may be obtained. Therefore, a surface-modified substrate may be used for various uses.

A substrate according to an exemplary embodiment of the present specification may be a film, a sheet, and a molded article, and is not limited thereto. The substrate according to an exemplary embodiment of the present specification has high hydrophilicity and scratch resistance due to the above-described surface modification, and thus may be very suitably used as an antifogging material, an antifouling (self-cleaning) material, an antistatic material, a quick-drying material, and the like. For example, the substrate may be used as a coated product used for exterior walls, exteriors, inner walls, interiors, and floors of buildings, ships, aircrafts, and vehicles, and the like.

In addition, the substrate according to an exemplary embodiment of the present specification may be used as a coated product used for clothing materials, such as clothes, cloths, and fibers; optical products, such as optical films, optical disks, glasses, contact lenses, and goggles; displays, such as flat panels and touch panels, and display materials thereof; glass substrates of solar cells or outermost protective transparent plates of solar cells; illuminating products, such as lamps and lights, and illuminating components thereof; cooling fins of heat exchangers; cosmetic containers and container materials thereof; reflective materials, such as reflective films and reflective plates; sound barriers placed in expressways, windowpanes, mirrors, furniture, furniture materials, bathroom materials, kitchen utensils, ventilating fans, pipes, wires, electric appliances, and electric components.

Increase in Adhesion and Decrease in Sheet Resistance Value

A substrate including the aluminum oxide composition according to an exemplary embodiment of the present specification has adhesion characteristics.

An exemplary embodiment of the present specification provides a substrate including: a substrate; an aluminum layer provided on at least one surface on the substrate and including one or more of aluminum, aluminum nitride, and aluminum oxynitride; and the above-described aluminum oxide composition provided on at least a portion of an upper surface and side surfaces of the aluminum layer.

In an exemplary embodiment of the present specification, an adhesion of the aluminum oxide composition is more than 100% of the adhesion of the aluminum layer. Specifically, the adhesion of the aluminum oxide composition may be more than 100% and 2,000% or less of the adhesion of the aluminum layer. More specifically, the adhesion of the aluminum oxide composition may be 150% or more and 1,000% or less of the adhesion of the aluminum layer.

When the adhesion of the aluminum oxide composition is more than 100% of the adhesion of the aluminum layer, mechanical properties may be improved by coating the surface of a base material with an adhesive material, or increasing fixed power with an adhesive disposed between films during the lamination of the films.

According to an exemplary embodiment of the present specification, examples of the method of measuring adhesion between the aluminum oxide composition and the aluminum layer include a peel test method, a lap shear test method, a pull out test method, a torque test method, a scratch test method, a stud/butt test, and the like, but are not limited thereto. Specifically, the adhesion between the aluminum oxide composition and the aluminum layer may be measured by a peel test method.

As a base material used for the measurement of the adhesion, a product name Scotch® Transparent Tape manufactured by 3M may be used, but the base material is not limited thereto.

In the present specification, a base material used for the measurement of adhesion may be any base material, and may be, for example, a resin film which has or does not have adhesion.

Furthermore, in an exemplary embodiment of the present specification, the aluminum oxide composition has a sheet resistance value of 10Ω/□ or less.

The sheet resistance value of the aluminum oxide composition may be measured by any method as long as the method is known in the art, and for example, a 4-point probe method may be used, but the method is not limited thereto.

In an exemplary embodiment of the present specification, an aluminum oxide composition is irregularly provided on at least a portion of an upper surface and side surfaces of the aluminum layer.

Being irregularly provided may mean being provided at an irregular position on an aluminum layer, and may also mean that the form of the aluminum oxide composition is provided in an irregular form.

In an exemplary embodiment of the present specification, the aluminum oxide composition may be provided in a form of an island, and has an irregular form.

For example, a substrate according to an exemplary embodiment of the present specification includes: a substrate 101; an aluminum layer 102 provided on at least one surface on the substrate 101; and an aluminum oxide composition 103 provided on at least a portion of an upper surface and side surfaces of the aluminum layer 102, as illustrated in FIG. 9.

In another exemplary embodiment, the aluminum oxide composition is provided on side surfaces of the aluminum layer. For example, a substrate according to an exemplary embodiment of the present specification includes: a substrate 101; an aluminum layer 102 provided on at least one surface on the substrate 101; and an aluminum oxide composition 103 provided on the entire side surfaces of the aluminum layer 102, as illustrated in FIG. 10.

In still another exemplary embodiment, the aluminum oxide composition is provided on side surfaces and an upper surface of the aluminum layer. For example, a substrate according to an exemplary embodiment of the present specification includes: a substrate 101; an aluminum layer 102 provided on at least one surface on the substrate 101; and an aluminum oxide composition 103 provided on an upper surface and the entire side surfaces of the aluminum layer 102, as illustrated in FIGS. 11 and 12.

According to an exemplary embodiment of the present specification, the range in which the aluminum oxide composition is produced may be adjusted according to the reaction time and the water temperature. Therefore, it is possible to manufacture a substrate with adhesion characteristics improved according to the surface roughness of the aluminum oxide composition by forming an aluminum oxide composition with a nano/micro size.

According to an exemplary embodiment of the present specification, after the immersing of the aluminum layer in water to form an aluminum oxide composition, the adhesion of the aluminum oxide composition is more than 100% of the adhesion of the aluminum layer within 60 seconds.

According to an exemplary embodiment of the present specification, after the immersing of the aluminum layer in water to form an aluminum oxide composition, the adhesion of the aluminum oxide composition is 150% or more of the adhesion of the aluminum layer within 60 seconds.

According to an exemplary embodiment of the present specification, after the immersing of the aluminum layer in water to form an aluminum oxide composition, the adhesion of the aluminum oxide composition is 150% or more of the adhesion of the aluminum layer at a water temperature of 70° C. within 30 seconds.

According to an exemplary embodiment of the present specification, after the immersing of the aluminum layer in water to form an aluminum oxide composition, the sheet resistance value of the aluminum oxide composition is maintained at 10Ω/□ or less at a water temperature of 70° C. or less for 120 seconds.

According to an exemplary embodiment of the present specification, after the immersing of the aluminum layer in water to form an aluminum oxide composition, the sheet resistance value of the aluminum oxide composition is maintained at 5Ω/□ or less at a water temperature of 70° C. or less for 120 seconds.

According to an exemplary embodiment of the present specification, after the immersing of the aluminum layer in water to form an aluminum oxide composition, the sheet resistance value of the aluminum oxide composition is maintained at 2Ω/□ or less at a water temperature of 70° C. or less for 120 seconds.

According to an exemplary embodiment of the present specification, the reaction time may be adjusted to 30 to 200 seconds according to the reaction temperature in order to obtain a target sheet resistance value. For example, at a water temperature of 70° C., the sheet resistance value of the aluminum oxide composition was 0.5Ω/□ in a reaction time of 50 seconds to 100 seconds, the sheet resistance value of the aluminum oxide composition was 1.7Ω/□ in a reaction time of 120 seconds, and the sheet resistance value of the aluminum oxide composition was 38.8Ω/□ in a reaction time of 180 seconds.

Further, at a water temperature of 100° C., the sheet resistance value of the aluminum oxide composition may be 40Ω/□ within a reaction time of 30 seconds.

The sheet resistance value of the aluminum oxide composition is affected by the reaction rate of the oxidation reaction, and may be rapidly decreased when the reaction temperature is 70° C. or more.

A substrate according to an exemplary embodiment of the present specification may be a film, a sheet, and a molded article, and is not limited thereto. The substrate according to an exemplary embodiment of the present specification has high hydrophilicity and scratch resistance due to the above-described surface modification, and thus may be very suitably used as an antifogging material, an antifouling (self-cleaning) material, an antistatic material, a quick-drying material, and the like. For example, the substrate may be used as a coated product used for exterior walls, exteriors, inner walls, interiors, and floors of buildings, ships, aircrafts, and vehicles, and the like.

In addition, the substrate according to an exemplary embodiment of the present specification may be used as a coated product used for clothing materials, such as clothes, cloths, and fibers; optical products, such as optical films, optical disks, glasses, contact lenses, and goggles; displays, such as flat panels and touch panels, and display materials thereof; glass substrates of solar cells or outermost protective transparent plates of solar cells; illuminating products, such as lamps and lights, and illuminating components thereof; cooling fins of heat exchangers; cosmetic containers and container materials thereof; reflective materials, such as reflective films and reflective plates; sound barriers placed in expressways, windowpanes, mirrors, furniture, furniture materials, bathroom materials, kitchen utensils, ventilating fans, pipes, wires, electric appliances, and electric components.

Decrease in Haze

A substrate including the aluminum oxide composition according to an exemplary embodiment of the present specification has characteristics of excellent transparency and a low haze value.

An exemplary embodiment of the present specification provides a substrate including: a substrate; an aluminum layer provided on at least one surface on the substrate and including one or more of aluminum, aluminum nitride, and aluminum oxynitride; and the above-described aluminum oxide composition provided on at least a portion of an upper surface and side surfaces of the aluminum layer.

The substrate according to an exemplary embodiment of the present specification may include a structure of the substrate as illustrated in FIGS. 9 to 12.

Another exemplary embodiment provides a substrate including: a substrate; and an aluminum oxide composition provided on at least one surface on the substrate.

For example, the substrate according to an exemplary embodiment of the present specification may provide a substrate including an aluminum oxide composition 103 provided on at least one surface on a substrate 101, as illustrated in FIG. 13.

In an exemplary embodiment of the present specification, a substrate including the aluminum oxide composition has a decreased haze value as compared to a substrate which does not include the aluminum oxide composition.

Specifically, the substrate including the aluminum oxide composition has a haze value which is decreased by 10% or more as compared to the substrate which does not include the aluminum oxide composition. More specifically, the substrate including the aluminum oxide composition has a haze value which is decreased by 15% or more as compared to the substrate which does not include the aluminum oxide composition. In an exemplary embodiment of the present specification, the substrate including the aluminum oxide composition has a haze value which is decreased by 30% or more as compared to the substrate which does not include the aluminum oxide composition. Specifically, the substrate including the aluminum oxide composition may have a haze value which is decreased by 80% or more as compared to the substrate which does not include the aluminum oxide composition.

When the haze value of the substrate is decreased as described above, the shape of an object transmitted through the substrate may be more clearly seen. Further, a desired haze value may be adjusted according to the time for immersing an aluminum layer in water and/or the temperature at which the aluminum layer is immersed in water.

In an exemplary embodiment of the present specification, a substrate including the aluminum oxide composition has an increased transmittance as compared to the substrate which does not include the aluminum oxide composition.

Specifically, in an exemplary embodiment of the present specification, the substrate including the aluminum oxide composition has a transmittance which is increased by 10% or more as compared to the substrate which does not include the aluminum oxide composition. In an exemplary embodiment of the present specification, the substrate including the aluminum oxide composition has a transmittance which is increased by 15% or more as compared to the substrate which does not include the aluminum oxide composition. In another exemplary embodiment, the substrate including the aluminum oxide composition has a transmittance which is increased by 30% or more as compared to the substrate which does not include the aluminum oxide composition. In an exemplary embodiment of the present specification, the substrate including the aluminum oxide composition has a transmittance which is increased by 50% or more as compared to the substrate which does not include the aluminum oxide composition.

In another exemplary embodiment, the substrate has a transmittance of 80% or more and less than 100%.

According to an exemplary embodiment of the present specification, the aluminum layer is in a form of a pattern, and the area of the aluminum layer is 20% or less as compared to the total area of the substrate.

In an exemplary embodiment of the present specification, the aluminum layer is in a form of a pattern, and has a line width of 10 μm or less. When the aluminum layer is applied to a device within the aforementioned range, the pattern may be invisible. The aluminum layer may have a line width of 5 μm or less, specifically 1 μm or less, and even more specifically 0.1 μm to 1 μm.

The line width of the aluminum layer means that a line width of the aluminum oxide composition is excluded from the line width of the initial aluminum pattern when the aluminum layer is in a form of a pattern. In FIG. 10, the width at the a portion corresponds to the line width of the aluminum pattern of the specification.

According to an exemplary embodiment of the present specification, the deviation in height between the aluminum layer and the aluminum oxide composition is 1.5 times or more.

According to an exemplary embodiment of the present specification, the thickness of the aluminum oxide composition may be larger than the thickness of the aluminum layer.

According to an exemplary embodiment of the present specification, the thickness of the aluminum layer after being immersed in water is increased by 1.5 times to 3 times as compared to the thickness of the aluminum layer before being immersed in water. While the aluminum layer is immersed in water so that an aluminum oxide composition is formed, hydrogen gas is generated or the volume is expanded.

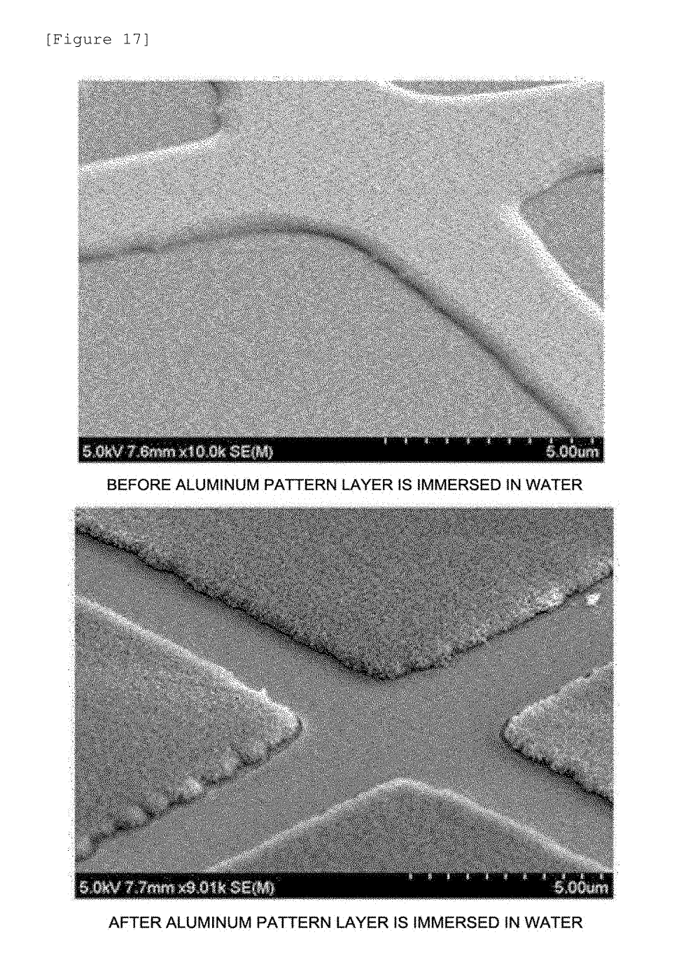

As a result of observing the thickness of the aluminum layer in FIG. 17, it can be confirmed that a thickness of 160 nm is increased to approximately 300 nm.

According to an exemplary embodiment of the present specification, after the immersing of the aluminum layer in water to form an aluminum oxide composition, the transmittance of the substrate is increased by 80% or more and less than 100% within 30 minutes from the time point when the aluminum layer is immersed in water.

According to an exemplary embodiment of the present specification, after the immersing of the aluminum layer in water to form an aluminum oxide composition, the transmittance of the substrate is increased by 18% or more within 5 minutes from the time point when the aluminum layer is immersed in water.

FIG. 18 is a view illustrating the transparency of the aluminum layer over the time when an aluminum layer is immersed in water. As a result of observing the transparency in FIG. 18, it can be confirmed that the transmittance is improved by 18.4% within 5 minutes from the time point when the aluminum layer is immersed in water, and from 5 minutes later, letters are visible due to high transparency.

According to another exemplary embodiment of the present specification, after the immersing of the aluminum layer in water to form an aluminum oxide composition, the transmittance of the substrate is increased by 90% or more within 20 minutes from the time point when the aluminum layer is immersed in water.

According to an exemplary embodiment of the present specification, after the immersing of the aluminum layer in water to form an aluminum oxide composition, the transmittance of the substrate is increased by 10% to 50% as compared to that of the substrate before being immersed in water.

According to another exemplary embodiment of the present specification, after the immersing of the aluminum layer in water to form an aluminum oxide composition, it is possible to expect an effect in that the reflectance of the substrate in a visible light region is improved by 5% or more as compared to the reflectance of the substrate within 30 minutes from the time point when the aluminum layer is immersed in water.

According to an exemplary embodiment of the present specification, after the immersing of the aluminum pattern in water to oxidize the aluminum pattern, the line width of the aluminum pattern is decreased by 10% to 30% within 5 minutes from the time point when the aluminum layer is immersed in water.

Further, according to an exemplary embodiment of the present specification, after the immersing of the aluminum layer in water to form an aluminum oxide composition, the haze value of the substrate is decreased by 30% or more within 30 minutes from the time point when the aluminum layer is immersed in water. The decrease in haze value is generated due to random light scattering while an aluminum oxide composition having a nano/micro structure is formed on the surface of the aluminum layer in the immersing of the aluminum layer in water to form an aluminum oxide composition.

FIG. 15 is a view illustrating an observation of the surface of an aluminum oxide composition formed by immersing an aluminum layer in water. In FIG. 15, it can be confirmed that in the forming of the aluminum layer in water to form an aluminum oxide composition, an aluminum oxide composition having a nano/micro structure is formed on the surface of the aluminum layer.

In another exemplary embodiment, the present specification provides a film including the above-described substrate.

According to an exemplary embodiment of the present specification, a pitch of the aluminum layer before being immersed in water may be 50 μm to 500 μm, but is not limited thereto and may be adjusted by the person skilled in the art, if necessary.

In the present specification, the pitch of the aluminum layer means a width between patterns, and means a width between a middle of the n-th pattern and a middle of the n+1-th pattern.

Since an aluminum oxide composition is produced from a portion brought into contact with water in the aluminum pattern, the pitch of the aluminum pattern after being immersed in water is not changed.

According to an exemplary embodiment of the present specification, it is possible to expect an effect in that the reflectance of a substrate including the aluminum oxide composition in a visible light region is improved by 5% or more as compared to the reflectance of the substrate.

In the present specification, “a visible light region” means a wavelength range from 380 nm to 800 nm.

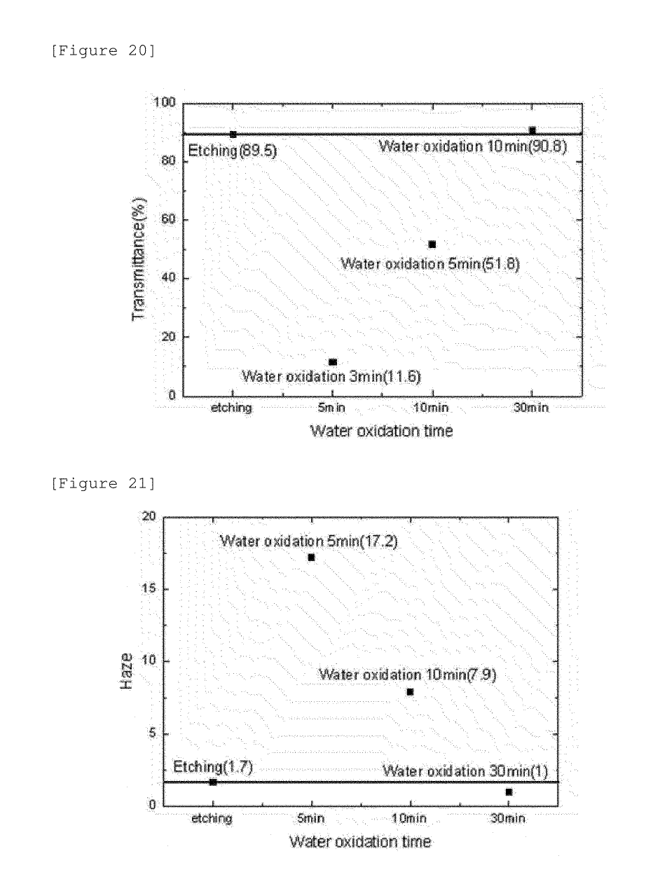

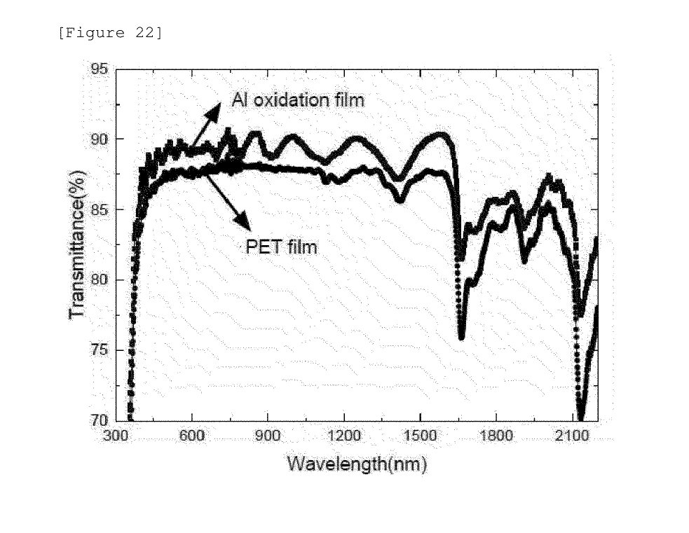

FIGS. 20 and 21 are a transmittance graph and a haze graph over the time when the aluminum layer is immersed in water, respectively.

From the results of FIGS. 20 and 21, it can be confirmed that as the time when the aluminum layer is immersed in water is increased, the transmittance is increased, and the haze value is decreased.

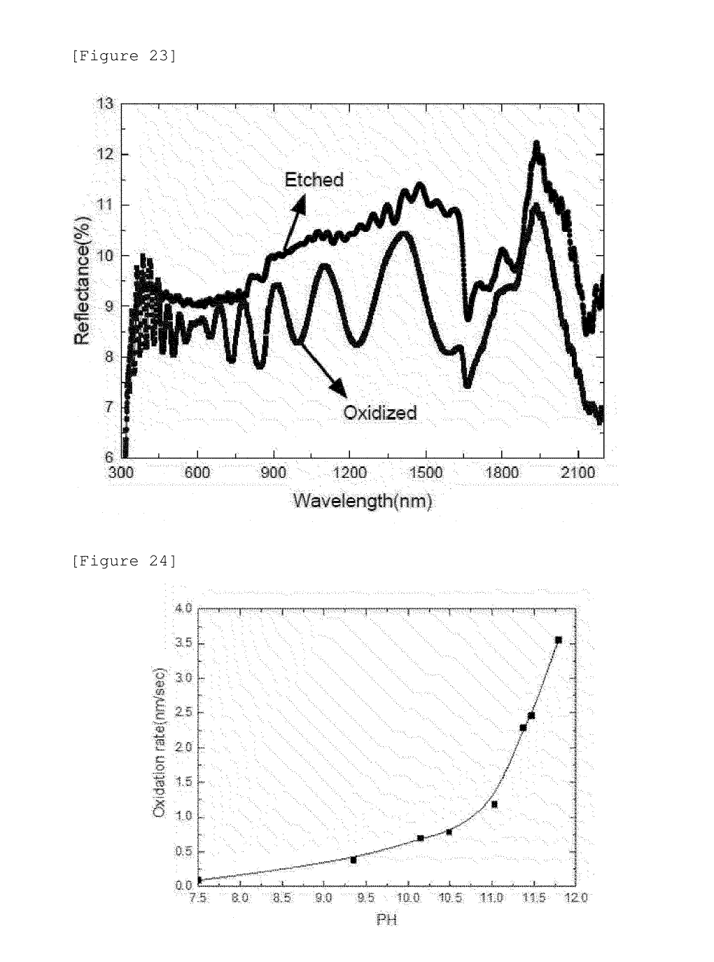

Further, FIGS. 22 and 23 of the present specification are views illustrating the transmittance and reflectance of a substrate including an aluminum oxide composition and a substrate which does not include the aluminum oxide composition, respectively.

From the results of FIGS. 22 and 23, it can be confirmed that the substrate including the aluminum oxide composition according to an exemplary embodiment of the present specification exhibits excellent characteristics in terms of reflectance and transmittance.

### MODE FOR INVENTION

Hereinafter, the present specification will be described in detail with reference to Examples for specifically describing the present specification. However, the Examples according to the present specification may be modified in various forms, and it is not interpreted that the scope of the present specification is limited to the Examples described below. The Examples of the present specification are provided for more completely explaining the present specification to the person with ordinary skill in the art.

### Example 1: Adjustment of Surface Roughness Using Aluminum Oxide Composition

Aluminum/aluminum oxide/polyethylene terephthalate (Al/PET) was immersed in distilled water (DI water) at 100° C.

The surface of the Al/PET was observed by a scanning electron microscope (SEM) over the time when the Al/PET was immersed in water.

FIG. 15 is a view illustrating the surface of the aluminum layer observed by a scanning electron microscope (SEM) over the time when the aluminum layer is immersed in water.

As a result of observing the surface of the aluminum layer over the time when the aluminum layer is immersed in water in FIG. 15, it can be seen that the oxidation of the aluminum layer proceeds from the surface to the depth direction while the oxidation is accelerated over the time when the aluminum layer is immersed in water, and it can be confirmed that the surface roughness is changed, and an irregular aluminum oxide composition is provided within 1 minute.

### Example 2: Change in Contact Angle Characteristics of Aluminum Oxide Composition

Aluminum/polyethylene terephthalate (Al/PET) was immersed in distilled water (DI water) at 100° C. The surface of the Al/PET was observed by a scanning electron microscope (SEM) over the time when the Al/PET was immersed in water, and the contact angle was measured.

FIG. 14 is a view illustrating the contact angle of a substrate with respect to water before and after immersing the substrate in water.

FIG. 14 is a view illustrating the comparison between the states before and after the substrate is immersed in water. It can be seen that after the substrate is immersed in water, the contact angle of the substrate with respect to water is changed from 92.2 degrees to 3.5 degrees or less.

### Example 3: Change in Adhesion Characteristics Over Water Temperature and Time

An alloy metal including aluminum/aluminum oxide/aluminum at a predetermined ratio of 30% or more was immersed in distilled water (DI water) at 40° C. or 70° C.

A metal included in the alloy metal may be one or two or more selected from the group consisting of Cu, Ni, Si, Mg, Ag, Au, Zn, Ti, Fe, and Cr, and is not limited as long as the metal may be generally combined with aluminum.

The following Table 1 is the results of the measurement of adhesion in order to confirm that the adhesion characteristics of the aluminum oxide composition are improved over the water temperature and the reaction time. In order to measure the adhesion, a peel test was performed by utilizing a Scotch Tape manufactured by 3M.

The Scotch Tape manufactured by 3M is a product name Scotch® Transparent Tape, and a size of 20 mm×50 mm was used in order to measure the adhesion.

TABLE 1

| Water temperature | Oxidation reaction | |
|---|---|---|
| (° C.) | time (sec) | Adhesion (gf/inch) |
| 40 | 0 | 340 |
| | 30 | 343 |
| | 60 | 415 |
| | 90 | 520 |
| | 120 | 634 |
| | 150 | 643 |
| | 180 | 715 |
| 70 | 0 | 340 |
| | 30 | 550 |
| | 60 | 600 |
| | 90 | 1,100 (Maximum value) |
| | 120 | 1,100 (Maximum value) |
| | 180 | 1,100 (Maximum value) |

For the adhesion of the aluminum layer before the oxidation reaction of aluminum in Table 1, it could be confirmed that the adhesion of aluminum, which exhibited a 100% adhesion, was increased as the water temperature used in the oxidation reaction and the reaction time were increased while the oxidation reaction proceeded.

In Table 1, it could be seen that the adhesion of the aluminum oxide composition was more than 150% of the adhesion of the aluminum layer before the oxidation reaction at a reaction temperature of 70° C. within a reaction time of 30 seconds, the adhesion of the aluminum oxide composition was more than 170% of the adhesion of the aluminum layer before the oxidation reaction within 60 seconds, and the adhesion of the aluminum oxide composition was more than 300% of the adhesion of the aluminum layer before the oxidation reaction at a reaction temperature of 70° C. for a reaction time of 90 seconds or more.

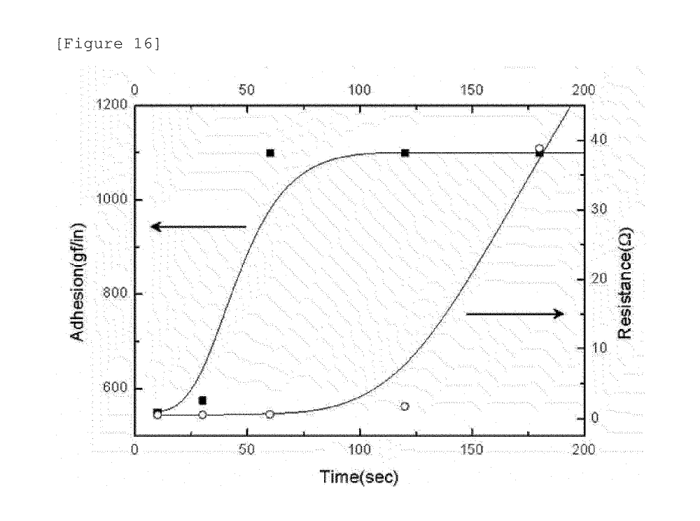

The observation may also be confirmed in the graph of FIG. 16, and it can be seen that as the oxidation reaction time is increased, the adhesion characteristics of the aluminum oxide composition formed is improved.

### Example 4: Change in Electric Conductivity and Sheet Resistance Characteristics Over Water Temperature and Reaction Time

An alloy metal including aluminum/aluminum oxide/aluminum at a predetermined ratio of 30% or more was immersed in distilled water (DI water) at 70° C.

A metal included in the alloy metal may be one or two or more selected from the group consisting of Cu, Ni, Si, Mg, Ag, Au, Zn, Ti, Fe, and Cr, and is not limited as long as the metal may be generally combined with aluminum.

The following Table 2 exhibits a change in electric conductivity characteristics of the aluminum oxide composition over the oxidation reaction time. In order to measure the change in sheet resistance of the aluminum oxide composition formed by an oxidation reaction of aluminum, a 4-point probe method was used.

TABLE 2

| | 1 | 2 | 3 | 4 | 5 | 6 | 7 | 8 | 9 | 10 | 11 | 12 | 13 | 14 | 15 | 16 | 17 | average |
|---|---|---|---|---|---|---|---|---|---|---|---|---|---|---|---|---|---|---|
| 0 sec | 0.6 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.6 | 0.511 |
| 10 sec | 0.5 | 0.5 | 0.5 | 0.6 | 0.6 | 0.5 | 0.5 | 0.6 | 0.5 | 0.6 | 0.5 | 0.5 | 0.5 | 0.5 | 0.6 | 0.5 | 0.5 | 0.523 |
| 20 sec | 0.5 | 0.6 | 0.5 | 0.6 | 0.5 | 0.5 | 0.5 | 0.5 | 0.5 | 0.5 | 0.5 | 0.5 | 0.5 | 0.5 | 0.5 | 0.5 | 0.5 | 0.511 |
| 60 sec | 0.6 | 0.6 | 0.6 | 0.5 | 0.6 | 0.6 | 0.5 | 0.6 | 0.5 | 0.6 | 0.5 | 0.6 | 0.6 | 0.5 | 0.6 | 0.6 | 0.6 | 0.570 |
| 120 sec | 1.7 | 1.4 | 1.4 | 1.5 | 2.2 | 2.7 | 2.0 | 1.8 | 1.9 | 1.7 | 1.6 | 1.5 | 1.6 | 1.6 | 1.4 | 1.4 | 2.0 | 1.73 |
| 180 sec | 16.1 | 13.2 | 6.5 | 10.1 | 15.1 | 78.0 | 78.0 | 45.6 | 56.1 | 23.1 | 62.4 | 74.6 | 31.8 | 16.2 | 41.4 | 55.2 | 37.0 | 38.84 |

In Table 2, the vertical axis is the oxidation reaction time, and the horizontal axis is the number of measurements of the sheet resistance value. When the oxidation reaction time is within 60 seconds, the sheet resistance of the aluminum oxide composition is 0.57, and it can be seen that the value is maintained at 120% or less with respect to the sheet resistance of the aluminum layer before the oxidation reaction.

The observation may also be confirmed in the graph of FIG. 16, and it can be seen that within an oxidation reaction time of 60 seconds, the adhesion is excellent while maintaining the sheet resistance value of the aluminum oxide composition.

### Example 5: Adjustment of Transmittance Using Aluminum Oxidation Reaction

An aluminum layer was deposited to have a thickness of 150 nm on polyethylene terephthalate (PET) (manufacturer: Mitsubishi) having a thickness of 125 μm, and the resulting aluminum layer was immersed in distilled water (DI water) at 100° C.

The transmittance was observed over the time when the aluminum layer was immersed in water.

FIG. 18 is a view illustrating an observation of the transmittance over the time when an aluminum layer is immersed in water, and FIG. 19 is a graph showing the transmittance over the time when an aluminum layer is immersed in water. As a result of observing the transmittance over the time when the aluminum layer is immersed in water in FIGS. 18 and 19, it could be confirmed that the transmittance was increased by 18.4% within 5 minutes, and the transmittance was increased by 90% or more within 20 minutes.

### Comparative Examples 1 and 2 and Examples 6 and 7: Adjustment of Transmittance and Haze Using Aluminum Oxidation Reaction

In Comparative Example 1, polyethylene terephthalate (PET) (manufacturer: Mitsubishi) having a thickness of 125 μm was used, and in Comparative Example 2, polyethylene terephthalate (PET) (manufacturer: Mitsubishi) having a thickness of 100 μm was used.

In Example 6, an aluminum layer was deposited on polyethylene terephthalate (PET) (manufacturer: Mitsubishi) having a thickness of 125 μm, and the resulting aluminum layer was immersed in distilled water) (DI water) at 100° C.

Further, in Example 7, an aluminum layer was deposited on polyethylene terephthalate (PET) (manufacturer: Mitsubishi) having a thickness of 100 μm, and the resulting aluminum layer was immersed in distilled water (DI water) at 100° C. for 30 minutes.

TABLE 3

| | Reaction | Transmittance | | | | |
|---|---|---|---|---|---|---|
| | time (min) | (%) | Haze | L | a | b |
| Comparative | | 89.5 | 1.7 | 95.23 | −0.37 | 1.46 |
| Example 1 | | | | | | |
| Comparative | | 92.8 | 0.5 | 96.80 | −0.02 | 0.66 |
| Example 2 | | | | | | |
| Example 6 | 5 | 11.6 | 17.2 | 40.37 | 0.43 | −8.01 |
| | 10 | 51.8 | 7.2 | 75.3 | −0.30 | 2.13 |
| | 30 | 90.7 | 1.0 | 95.7 | −0.51 | 1.11 |
| Example 7 | 30 | 95.9 | 0.3 | 98.10 | 0.11 | 0.78 |

In Table 3, the sample treated for 30 minutes, which determined that the oxidation reaction of the aluminum layer had been completely terminated in a depth direction, exhibited a transmittance of 90.7% and a haze value of 1.0, showing light characteristics improved by 40% or more as compared to Comparative Example 1.

Furthermore, Example 7 exhibited light characteristics in which the transmittance was increased by 3% or more and the haze value was improved by 40% as compared to Comparative Example 2.

The results could also be confirmed from the transmittance graph over the time when the aluminum layer was immersed in water in FIG. 20 and the haze graph over the time when the aluminum layer was immersed in water in FIG. 21. In FIGS. 20 and 21, it could be seen that as the oxidation reaction time of the aluminum layer is increased, the transmittance was increased and the haze value was decreased.

The haze was measured by a haze meter HM-150 of an A light source, and the transmittance, lightness index (L), and perception chromaticity index (a and b) were measured by COH-400 of a D65 light source.

### Evaluation Example 1 of Comparative Example 1 and Example 6: Stability Experiment

A stability experiment was performed on the substrates manufactured in Comparative Example 1 and Example 6. The samples in Comparative Example 1 and Example 6 were left to stand in a pressure cooker test (PCT) chamber at 85° C. for 1 day.

TABLE 4

| | Reaction | | | | | |
|---|---|---|---|---|---|---|
| | time | Transmittance | | | | |
| | (min) | (%) | Haze | L | a | b |
| Comparative | | 88.8 | 1.9 | 95.34 | −0.53 | 1.31 |
| Example 1 | | | | | | |
| Example 6 | 5 | 25.1 | 17.5 | 56.20 | 0.64 | −4.77 |
| | 10 | 72.3 | 4.7 | 88.13 | −0.41 | −0.08 |
| | 30 | 90.4 | 1.2 | 96.03 | −0.61 | 1.12 |

In Table 4, it could be seen that the samples treated for 30 minutes in Comparative Example 1 and Example 6 were relatively stable and thus had no significant difference in before and after the stability experiment, but in the case of the samples treated for 5 minutes and 10 minutes in Example 6, an additional oxidation reaction occurred due to moisture permeated through a PET rear surface, and as a result, the transmittance was increased, and the haze value was decreased.

The haze was measured by a haze meter HM-150 of an A light source, and the transmittance, lightness index (L), and perception chromaticity index (a and b) were measured by COH-400 of a D65 light source.

### Evaluation Example of Comparative Example 2 and Example 7: Transmittance and Reflectance Experiment

A reflectance and transmittance experiment was performed on the substrates manufactured in Comparative Example 2 and Example 7. From the samples in Comparative Example 2 and Example 7, the transmittance and reflectance were measured in a region from 300 nm to 2,300 nm. The results are illustrated in FIGS. 22 and 23.

FIG. 22 is a graph showing the transmittances of the substrates manufactured in Comparative Example 2 and Example 7 in a region from 300 nm to 2,300 nm, and FIG. 23 is a graph showing the reflectances of the substrates manufactured in Comparative Example 2 and Example 7 in a region from 300 nm to 2,300 nm.

In FIG. 21, the transmittance of the substrate manufactured in Example 7 was shown to be higher than that of the substrate in Comparative Example 2, and in FIG. 22, it could be seen that the reflectance of the substrate manufactured in Example 7 exhibited an improved effect by 5% or more as compared to that of the substrate in Comparative Example 2 within a region from 300 nm to 2,300 nm, particularly, in a range from 380 nm to 800 nm, which is a visible light region.

### Example 8: Adjustment of Production Rate of Aluminum Oxide Composition Over pH of Water

Aluminum/polyethylene terephthalate (Al/PET) with a size of 10×10 cm² was immersed in distilled water) (DI water) at 100° C. The pH of the aqueous solution was adjusted by adding KOH and HNO₃ to the distilled water, and the production rate of the aluminum oxide composition, which is calculated by measuring the time at the time point when the metallic color of aluminum and oxide observed by the unaided eye completely disappears, is described in Table 5.

TABLE 5

| | | | Time | Oxidation Rate | Transmittance |
|---|---|---|---|---|---|
| Sample Type | | PH | (sec) | (nm/sec) | (Tt) |
| Neutral | Ref. | 7.0 | 1,800 | 0.0889 | 91.36 |
| (DI | | | | | |
| water) | | | | | |
| Basic | #1 | 11.79 | 45 | 3.5556 | 93.37 |
| | #2 | 11.47 | 65 | 2.4615 | 93.54 |
| | #3 | 11.37 | 70 | 2.2857 | 94.02 |
| | #4 | 11.03 | 135 | 1.1852 | 94.64 |
| | #5 | 10.49 | 205 | 0.7805 | 94.50 |
| | #6 | 10.15 | 230 | 0.6957 | 94.19 |
| | #7 | 9.35 | 420 | 0.3809 | 93.64 |
| Acidic | #8 | 4.03 | >1,800 | — | — |

FIG. 24 is a view illustrating the production rate of an aluminum oxide composition over the pH range of water. From the results of FIG. 24, it can be confirmed that as the basicity of water is increased, the production rate of the aluminum oxide composition is significantly increased.

From the results of FIG. 24 and Table 5, it can be confirmed that when an aluminum layer is immersed in water further including a base, the production rate of an aluminum oxide composition is increased.

Therefore, the aluminum oxide composition according to an exemplary embodiment of the present specification may be produced by being immersed in neutral or basic water at 40° C. to 100° C.

1. (canceled)

2. A substrate comprising:
a substrate;
an aluminum layer provided on at least one surface on the substrate and comprising one or more of aluminum, aluminum nitride, and aluminum oxynitride; and
the aluminum oxide composition provided on at least a portion of an upper surface and side surfaces of the aluminum layer,
wherein the aluminum oxide composition is provided at 90% or more of an area of one surface of the aluminum layer facing the substrate,
wherein the aluminum layer is in a form of a film, and
wherein the substrate has a transmittance of 80% or more and less than 100%.

3. (canceled)

4. The substrate of claim 2, wherein a contact angle of the substrate with respect to water is 10 degrees or less.

5. (canceled)

6. The substrate of claim 2, wherein an adhesion of the aluminum oxide composition is more than 100% of the adhesion of the aluminum layer.

7. The substrate of claim 2, wherein the substrate comprising the aluminum oxide composition has a haze value which is decreased as compared to a substrate which does not comprise the aluminum oxide composition.

8-10. (canceled)

11. A method for preparing an aluminum oxide composition, the method comprising:
immersing an aluminum layer comprising one or more of aluminum, aluminum nitride, and aluminum oxynitride in water,
wherein the water further comprises a base, and
wherein a PH range of the water is pH 7 to pH 13.

12. The method of claim 11, wherein a temperature of the water is 40° C. to 100° C.

13. The method of claim 11, wherein the aluminum layer is immersed in water for 30 minutes or less.

14-15. (canceled)

16. A method for manufacturing a substrate, the method comprising:
preparing a substrate;
forming an aluminum layer comprising one or more of aluminum, aluminum nitride, and aluminum oxynitride on at least one surface on the substrate; and
forming an aluminum oxide composition on at least a portion of an upper surface and side surfaces of the aluminum layer by the method for preparing an aluminum oxide composition according claim 11.
